(19) United States
(12) Patent Application Publication
(10) Pub. No.: US 2023/0018387 A1
(43) Pub. Date: Jan. 19, 2023

(54) DYNAMIC WEB PAGE CLASSIFICATION IN WEB DATA COLLECTION

(71) Applicant: Metacluster LT, UAB, Vilnius (LT)

(72) Inventors: Andrius KUKSTA, Vilnius (LT); Jurijus GORSKOVAS, Vilnius (LT); Martynas JURAVICIUS, Vilnius (LT)

(73) Assignee: Metacluster LT, UAB, Vilnius (LT)

(21) Appl. No.: 17/368,636

(22) Filed: Jul. 6, 2021

(51) Int. Cl. G06N 5/02; G06F 16/958

(52) U.S. Cl. CPC G06N 5/022; G06F 16/986

(57) ABSTRACT

The current application discloses processor-implemented methods and systems of processing unclassified HTML responses collected in the context of a data collection service, the method comprising, in one embodiment, receiving unclassified HTML documents, isolating elements relevant for category identification, deriving classification attributes from the isolated elements, and applying a Machine Learning-based classification model resulting in HTML data items classified and labelled accordingly. In certain embodiments the Machine Learning model may be a model trained on a pre-created training data set labeled manually or in an automatic fashion.

### FIELD

The methods and systems detailed herein relate to processing response data in the context of a data collection service, wherein the processing employs a data preparation toolset for further handling by a trained Machine Learning classification model.

BACKGROUND

Web scraping (also known as screen scraping, data mining, web harvesting) in its most general sense is the automated gathering of data from the internet. More technically, it is the practice of gathering data from the internet through any means other than a human using a web browser or a program interacting with an application programming interface (API). Web scraping is usually accomplished by executing a program that queries a web server and requests data automatically, then parses the data to extract the requested information.

Web scrapers—programs written for web scraping—can have a significant advantage over other means of accessing information, like web browsers. The latter are designed to present information in a readable way for humans, whereas web scrapers are excellent at collecting and processing large amounts of data quickly. Rather than opening one page at a time through a monitor (as web browsers do), web scrapers are able to collect, process, aggregate and present large databases of thousands or even millions of pages at once.

Sometimes a website allows another automated way to transfer its structured data from one program to another via an API. Typically, a program will make a request to an API via Hypertext Transfer Protocol (HTTP) for some type of data, and the API will return this data from the website in a structured form. It serves as a medium to transfer the data. However, using APIs is not considered web scraping since the API is offered by the website (or a third party) and it removes the need for web scrapers.

An API can transfer well-formatted data from one program to another and the process of using it is easier than building a web scraper to get the same data. However, APIs are not always available for the needed data. Also, APIs often use volume and rate restrictions and limit the types and the format of the data. Thus, a user would use web scraping for the data for which an API does not exist, or which is restricted in any way by the API.

Usually, web scraping includes the following steps: retrieving Hypertext Markup Language (HTML) data from a website; parsing the data for the desired target information; saving the desired target information; and repeating the process if needed on another page. A web scraper is a program that is designed to do all these steps on a large scale. A related program—a web crawler (also known as a web spider)—is a program or an automated script which performs the first task, i.e., it navigates the web in an automated manner to retrieve raw HTML data of the accessed web sites (the process also known as indexing).

Scraping activity may be performed by multiple types of scraping applications that can be generally categorized, for example, as browser, headless browser, command line tools, programming language library, etc.

Browser—an application executed within a computing device, usually in the context of an end-user session, with the functionality sufficient to accept the user's request, pass it to the Target Web server, process the response from the Web server, and present the result to the user. Browser is considered a user-side scripting enabled tool, e.g., capable of executing and interpreting JavaScript code.

Headless browser—a web browser without a graphical user interface (GUI). Headless browsers provide automated control of a web page in an environment similar to popular web browsers but are executed via a command-line interface or using network communication. They are particularly useful for testing web pages as they are able to render and understand HTML the same way a browser would, including styling elements such as page layout, color, font selection and execution of JavaScript and AJAX which are usually not available when using other testing methods. Two major use cases can be identified:

scripted web page tests—with the purpose of identifying bugs, whereas a close resemblance to a user activity is necessary.

web scraping—where resemblance to a user activity is mandatory to avoid blocking. i.e. the request should possess all the attributes of an organic Web browsing request.

Headless browser is considered a user-side scripting enabled tool, e.g., capable of executing and interpreting JavaScript code.

Command line tools—GUI-less applications that allow to generate and submit a Web request through a command line terminal e.g. CURL. Some tools in this category may have a GUI wrapped on top, but the graphical elements would not cover displaying the result of the HTTP request. Command line tools are limited in their functionality in that they are not capable of executing and interpreting JavaScript code.

Programming language library—a collection of implementations of behavior, written in terms of a language, that has a well-defined interface by which the behavior is invoked. For instance, when particular HTTP methods are to be invoked for executing scraping requests, the scraping application can use a library containing the methods to make system calls instead of implementing those system calls over and over again within the program code. In addition, the behavior is provided for reuse by multiple independent programs, where the program invokes the library-provided behavior via a mechanism of the language. Therefore, the value of a library lies in the reuse of the behavior. When a program invokes a library, it gains the behavior implemented inside that library without having to implement that behavior itself Libraries encourage the sharing of code in a modular fashion, and ease the distribution of the code. Programming language libraries are limited in their functionality in that they are not capable of executing and interpreting JavaScript code, unless there is another tool capable of user-side scripting, for which the library is a wrapper.

Combinations of the previous basic agent types, to a varying degree, implement

HTTP protocol methods and client-side scripting.

The scraping application types listed above vary in the technical capabilities they possess, often due to the very purpose the application has been developed for. While sending the initial request to the target Web server, all of the listed types of scraping applications pass the parameters mandatory for submitting and processing a web request. e.g., HTTP parameters—headers, cookies, declare the version of HTTP protocol they support and intend to communicate in, with Transmission Control Protocol (TCP) parameters disclosed while initiating the TCP session underlying the HTTP request (e.g. TCP Windows size and others). As described above, browsers and headless browsers can process the JavaScript files obtained within the web server's response e.g., submit configuration settings through JavaScript when requested, while command line utilities are incapable of doing that.

While processing the web server's response, all of the listed types of scraping applications are capable of obtaining, interpreting, rendering or otherwise processing, and presenting the HTTP metadata and the main HTML document, whereas some of the listed scraping applications do not possess the functionality of processing the additional files obtained from the web target's response e.g., executing scripted code client side. Therefore, a practical classification of web harvesting tools is based on their ability to execute and interpret JavaScript code.

Further disclosure of the overall data collection process may concentrate on overviewing the structure of a standard Web server request.

The response obtained from the web server generally includes the following parts:

HTTP metadata, containing HTTP headers, cookies and HTTP response code; the main HTML document; additional files needed to process and render the finalized version of the web page: images, Cascading Style Sheet (CSS) files and JavaScript (JS) scripts.

Simple HTML file contains the data formatted with the baseline HTML code, whereas MHTML file is a text file that contains full response data: main document (HTML), .css file—information about each element's styling, images, JavaScript files containing the uncompiled scripting code to be executed to render the finalized web page.

The Document Object Model (DOM) is a programming interface for HTML and

XML documents. It represents the page so that programs can change the document structure, style, and content. The DOM is an object-oriented representation of the web page, ensuring that programming languages can connect to the page and operate on the elements within. The W3C DOM and WHATWG DOM standards are implemented in most modern browsers. To extend further, all of the properties, methods, and events available for manipulating and creating web pages are organized into objects e.g., the document as a whole, the head, tables within the document, table headers, text within the table cells, etc.

The modern DOM is built using multiple APIs that work together. The core DOM defines the objects that fundamentally describe a document and the objects within it. This is expanded upon as needed by other APIs that add new features and capabilities to the DOM. For example, the HTML DOM API adds support for representing HTML documents to the core DOM.

Xpath is an essential element of processing a Web page is the possibility to navigate across the hierarchy of a DOM. The XPath language is based on a tree representation of the XML document, and provides the ability to navigate around the tree, selecting nodes by a variety of criteria. In popular use (though not in the official specification), an)(Path expression is often referred to simply as “an XPath”, wherein it contains a location of any element on a webpage using HTML DOM structure, defined in a syntax or language for finding any element on the web page using the XML path expression.

Whereas Xpath is an attribute of an HTML page element presenting the location within the DOM structure, an important parameter of an HTML page element is the “name”. A clear demonstration of the distinction follows:

```
<html>.
  <body>
    <div class=“content”>
    <h1 id=“title”>“Website ”</h1>
    </div>
  </body>
</html>
```

wherein “Xpath” of the element “hl” containing text “Website X” (html/body/div/hl) can be distinguished from HTML element names (“content”, “title”).

Since processing vast amounts of data manually is rarely effective or even feasible, supporting methodologies have evolved in the area of automated data analysis operations. One of such methods is Machine Learning.

Machine learning can be broadly defined as computational methods using aggregated data to improve performance or to make accurate predictions. Here, aggregated data refers to the past information available to the machine learning algorithm, which typically takes the form of electronic data collected and made available for analysis.

Potential use-cases for employing such methodology while performing data collection on a vast scale may be classifying a pre-compiled list of URLs before their full scraping occurs. Primary goal in this case is to filter out the pages that are not in line with the desired information thus reducing the scope of data collection effort.

Another exemplary objective of an automatic Webpage classification platform is classifying a pre-compiled list of URLs before fully collecting the data contained within in order to clearly identify the best strategy and toolset for each particular URL in the list, thus ensuring high quality of the data collected and avoiding the risk of misused resources.

### SUMMARY

The summary provided herein presents a primary or a general understanding of various aspects of exemplary embodiments disclosed in the detailed description accompanied by drawings. This summary is not intended, however, as an extensive or exhaustive overview. Instead, the only purpose of this summary is to present the condensed concepts related to the exemplary embodiments in a simplified form as a prelude to the detailed description.

In one aspect, the embodiment detailed here disclose methods and systems based on Machine Learning techniques to determine the category of web pages. The methods and systems include receiving the HTML content from a target web server, sending the received HTML content and the URL of the target web page to a classifier unit, parsing the HTML content to extract the entirety of the textual content, HTML element names (belonging, for example, to tags, classes, HTML element variables, etc.), metadata (for example, meta tags with their attributes and values, etc.). The methods and systems further include extracting specific classification attributes from the URL, textual content, HTML elements and meta elements to determine the category of the target web page based on the Machine Learning predictive analytics algorithm.

### DESCRIPTION OF DIAGRAMS

The features and advantages of the example embodiments described herein will become apparent to those skilled in the art to which this disclosure relates upon reading the following description, with reference to the accompanying drawings.

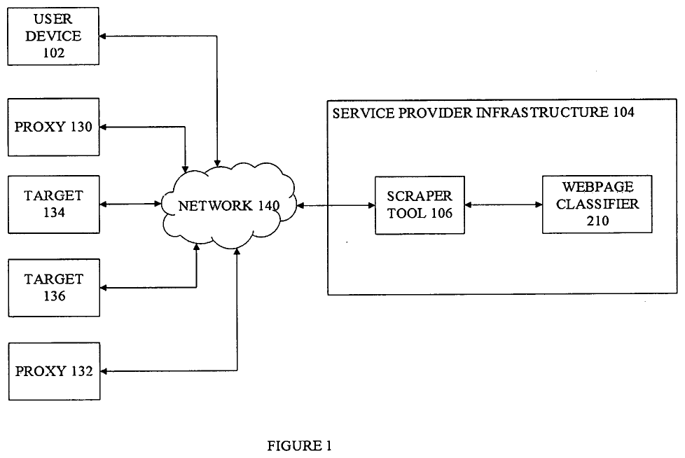

FIG. 1 is an exemplary block diagram showing the overall architecture of the disclosed components.

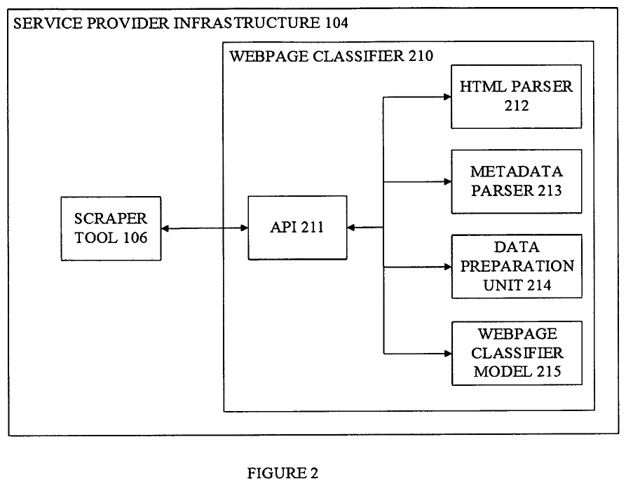

FIG. 2 is a more detailed depiction of the Webpage Classifier platform within the overall Service Provider infrastructure architecture.

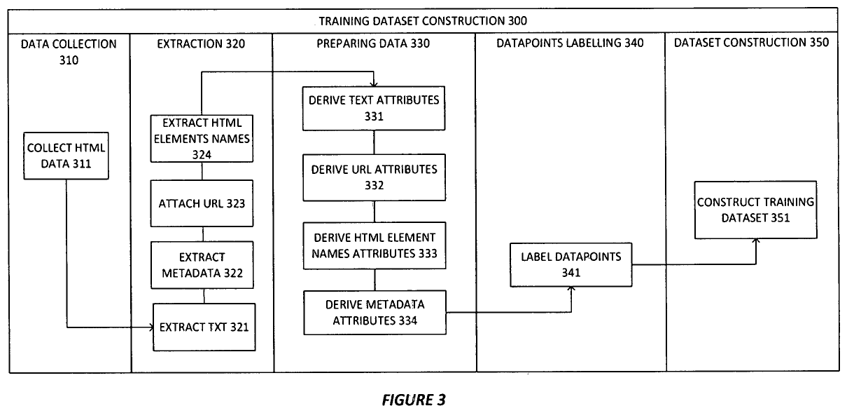

FIG. 3 demonstrates the construction of the Training dataset for the Webpage Classifier Model.

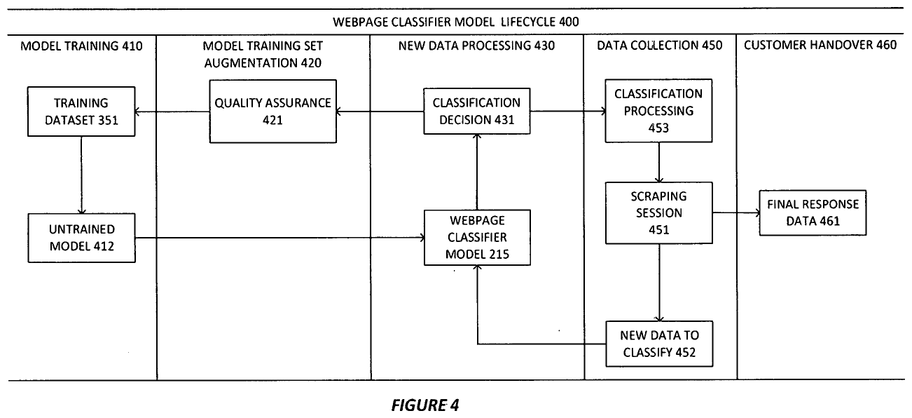

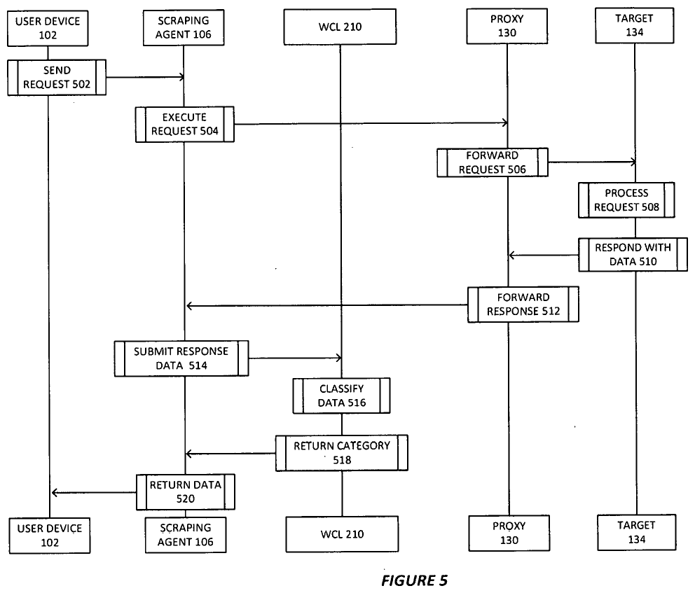

FIG. 4 depicts the lifecycle and the overall functioning of the Webpage Classifier Model, starting from the initial training phase, the processing of the actual requests, and the looped feedback model that updates the training dataset with the classification decisions that passed human examination.

FIG. 5 is an exemplary flow diagram, describing the overview of the route a scraping request takes.

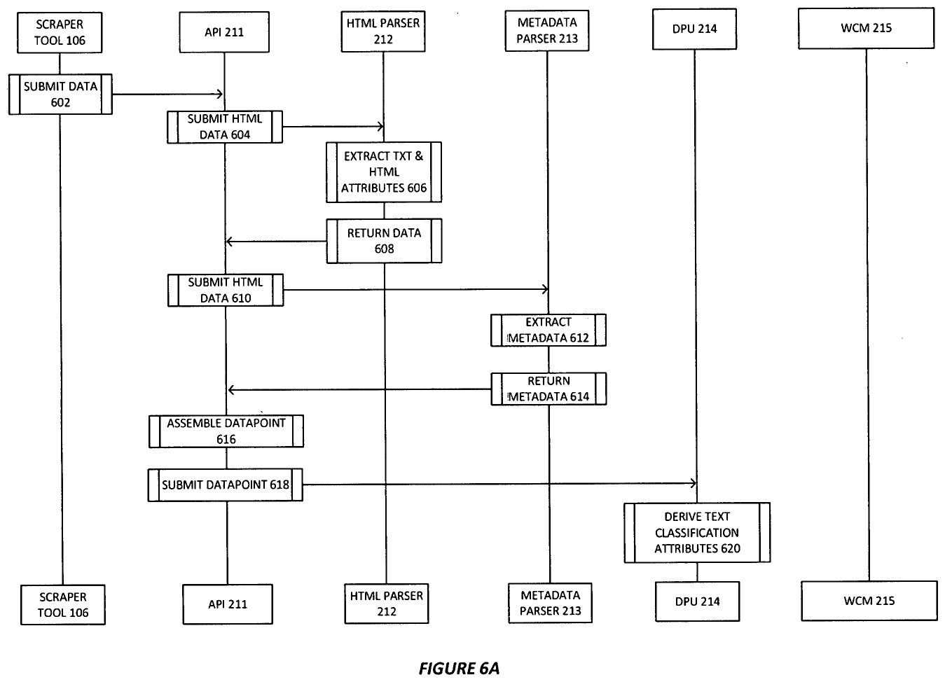

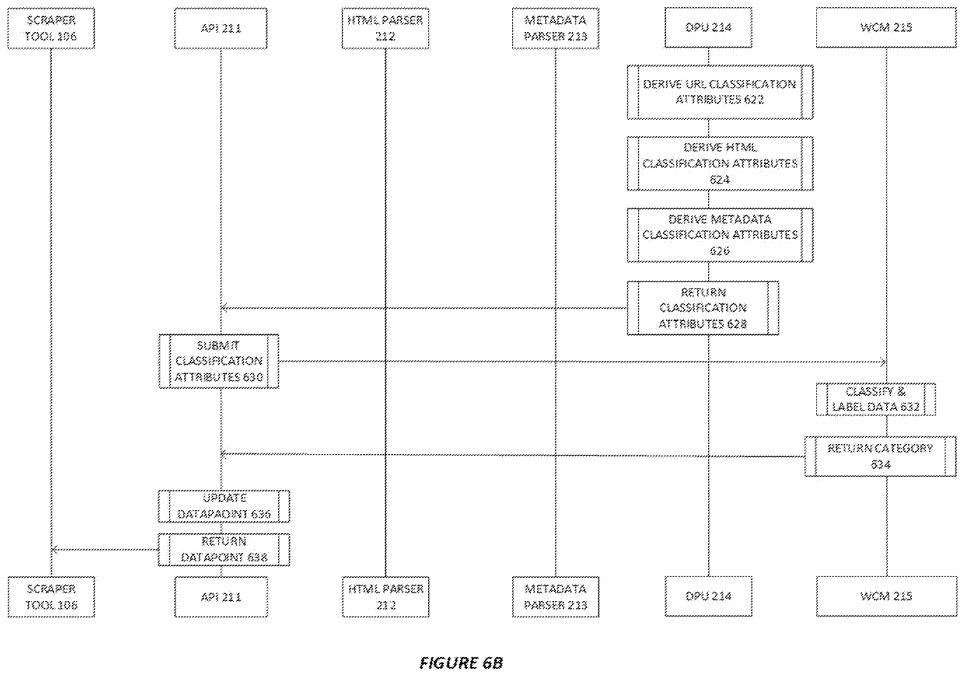

FIG. 6a is a depiction of the collected data classified and transformed.

FIG. 6b is a continuation of FIG. 6a, further depicting the process of data classified and transformed.

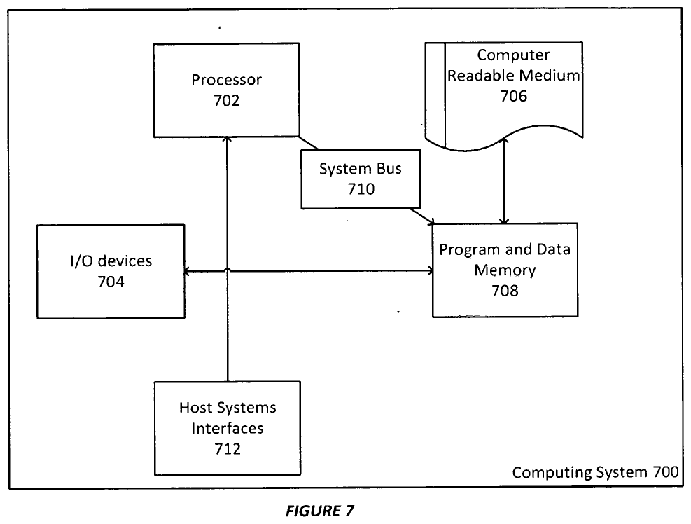

FIG. 7 is an exemplary computing system performing the methods disclosed.

### DETAILED DESCRIPTION

Data collection operations require massive computational and time resources, as well as result in a vast amount of data obtained. The benefits of employing Machine Learning-based classification functionality while processing both the input and the output of data collection are two-fold. First, classifying a pre-compiled list of URLs before their full scraping occurs to eliminate the pages that are not in line with the desired information thus reducing the scope of data collection effort.

Another exemplary advantage a Machine Learning-based Webpage classification platform brings into the high-scale data collection process is classifying a pre-compiled list of URLs before fully collecting the data contained within the corresponding Webpages in order to clearly identify the best strategy and toolset for each particular URL in the list, thus ensuring high quality of the data collected and avoiding the risk of misused resources.

Some general terminology descriptions may be helpful and are included herein for convenience and are intended to be interpreted in the broadest possible interpretation. Elements that are not imperatively defined in the description should have the meaning as would be understood by a person skilled in the art. Elements 104, 106, 108 and 210 identify parts of the Service Provider Infrastructure, while elements 102, 130, 132, 134, 136, and 140 depict external components or systems.

User Device 102 can be any suitable user computing device including, but not limited to, a smartphone, a tablet computing device, a personal computing device, a laptop computing device, a gaming device, a vehicle infotainment device, a smart appliance (e.g., smart refrigerator or smart television), a cloud server, a mainframe, a notebook, a desktop, a workstation, a mobile device, or any other electronic device used for making a scraping request.

Service Provider Infrastructure 104 (SPI 104) is the combination of the elements comprising the platform that provides for the service of collecting data from the Internet by executing data collection requests submitted by users, processing the collected data and handing the data over to the requesting user.

Scraping Agent 106 is a component of the Service Provider Infrastructure 104 that, among other things, is responsible for containing and running the scraping applications executing scraping requests originating from the commercial users, as well as accepting said requests from users. Consequently, another role of this element is to perform data collection operations according to the requests submitted to it. Upon obtaining response data from the Target system, or systems, Scraping Agent 106 either returns the data to the requesting party or, upon identifying additional processing necessary, performs such additional processing upon the data collected.

An aspect of Scraping Agent 106 functionality is, upon obtaining the response from the Target, to submit it for further processing to components responsible for additional data evaluation, classification, and transformation operations.

Webpage Classifier (WCL) 210 is the component of the SPI 104 responsible for accepting the calls from the Scraping Agent 106 and evaluating the data submitted within the calls, wherein the data is the content obtained during a data collection request, or multiple requests. The evaluation of said data comprises pre-processing the data contained therein, extracting relevant datapoints aligned with the original data collection request, classifying and labelling the resultant content, and ultimately returning the classified and labeled data to the Scraping Agent 106, providing the probability percentile for the classification identified. WCL 210 comprises multiple components that provide for the functionalities described.

Application Programming Interface (API) 211 is an internal component of WCL 210 responsible for external communication, integrations, as well as internal communication among WCL 210 components.

Application Programming Interface (API) 211 is orchestrating preparation of the data, as well as classification and labelling of the data provided by the Scraping Agent 106. The classification employs a Webpage Classifier Model 215 trained with a dataset specifically constructed from previously collected and labeled multiple data collection responses.

HTML Parser 212 is an internal component of WCL 210 that extracts the textual information from an HTML data, as well as the HTML meta information associated with the elements of a web page e.g., tags, classes, variables and their names assigned to HTML elements, to name but a few.

Metadata Parser 213 is the component of WCL 210 tasked with extracting metadata information within the web page undergoing classification. Metadata are tags used in HTML and XHTML documents to provide structured metadata about a Web page. They are part of a web page's head section. However, in some instances, metadata tags can be present in the body section of the HTML or XHTML documents. Multiple meta elements with different attributes can be used on the same page. Meta elements can be used to specify page description, keywords and any other metadata not provided through the other head elements and attributes. The meta element has two uses: either to emulate the use of an HTTP response header field, or to embed additional metadata within the HTML document e.g., “description” meta tags can be used to describe the contents of the page: <meta name=“description” content=“Product page”>, “keywords” may present a set of keywords the page should be associated with, as well as may be employed in ranking the page in search results. “Title” attribute may convey the page's general purpose, wherein the title is visible to the browsing user e.g., as page title in search results.

Dataset Preparation Unit (DPU) 214 is the container object that comprises all the components and functionalities required for pre-processing data before submitting the data for classification. The toolset contained therein is described in the current embodiments in an exemplary fashion and may be expanded with additional tools adapting to the Webpage Classifier Model 215 input requirements.

Webpage Classifier Model (WCM) 215 is an internal component of WCL 210 that classifies and labels the datapoints provided to it for classification based on observed patterns from the previous data i.e., the training dataset.

The actual Machine Learning-based classification model may be Bag of words, Naïve Bayes algorithm, Support vector machines, Logistic Regression, Random Forest classifier, eXtreme Gradient Boosting Model, Convolutional Neural Network, or Recurrent Neural Network.

Proxies 130 and 132 indicate an exemplary multitude of proxy servers (computer systems or applications) open for client connections, that act as an intermediary for requests from clients seeking resources from other servers. A client connects to the proxy server, requesting a service, such as a file, a connection, a web page, or other resources available from a different server. The proxy server evaluates the request for content and forwards the request to the target resource, or resources, containing the content. After obtaining the content, the proxy server normally forwards the content to the original requestor, but other actions by the proxy (for example, return an error message) can also be performed. In one aspect, in at least one of the embodiments detailed herein, a proxy server may not have full visibility into the actual content fetched for the original requestor, e.g., in case of an encrypted HTTPS session, if the proxy is not the decrypting end-point, the proxy serves as an intermediary blindly forwarding the data without being aware of what is being forwarded. However, the metadata of the response is always visible to the Service Provider, e.g., HTTP headers. This functionality is necessary for the proxy to correctly forward the data obtained to the correct requesting party—the end user or the mediating proxy device. Proxy 130 and Proxy 132 are presented here as a simple indication that there can be more than one proxy server held at the service provider infrastructure 104 or be available externally to be employed for performing the data collection operations. The embodiments should not be limited to the proxies that belong to the service provider. The proxies can be owned and managed by a third party; however it is assumed that the service provider infrastructure 104 has access and can use such proxies for servicing the scraping requests.

Targets 134 and 136 indicate an exemplary multitude of web servers serving content accessible through HTTP/HTTPS protocols. Target 134 and Target 136 are presented here as a simple indication that there can be more than one target, but it should not be understood in any way as limiting the scope of the disclosure. There can be an unlimited number of targets in the network.

Network 140 is a digital telecommunications network that allows nodes to share and access resources. Examples of a network: local-area networks (LANs), wide-area networks (WANs), campus-area networks (CANs), metropolitan-area networks (MANs), home-area networks (HANs), Intranet, Extranet, Internetwork, Internet.

FIG. 1 is an exemplary block diagram showing the overall architecture of the disclosed components. FIG. 1 shows User Device 102, Service Provider Infrastructure 104, Network 140, Proxy Servers 130, 132 and Targets 134, 136. The Service Provider Infrastructure 104 comprises Scraper Tool 106 and Webpage Classifier 210. It must be noted that User Device 102, Proxy Servers 130, 132 and Targets 134, 136 are not part of the Service Provider Infrastructure 104.

In FIG. 1, network 140 can be local-area networks (LANs), wide-area networks (WANs), campus-area networks (CANs), metropolitan-area networks (MANs), home-area networks (HANs), Intranet, Extranet, Internetwork, Internet. In the current disclosure, the Internet is the most relevant network for the functioning of the embodiments. Connection to network 140 may require that the user device 102, service provider infrastructure 104, proxy servers 130, 132 and targets 134, 136 execute software routines that enable, for example, the seven layers of the OSI model of the telecommunication network or an equivalent in a wireless telecommunication network.

While the elements shown in FIG. 1 implement an exemplary embodiment, in practice, and as recognized by a person skilled in the art, some components shown in FIG. 1 can have different titles or can be combined into a single component instead of two separate components. However, the functionality of components and the flow of information between the components is not impacted generally by such combinations or consolidations. Therefore, FIG. 1, as shown, should be interpreted as exemplary only and not restrictive or exclusionary of other features, including features discussed in other areas of this disclosure.

In FIG. 1, user device 102 initially sends a data collection request to scraper tool 106 present within the service provider infrastructure 104. Scraper tool 106 receives and executes the request from user device 102 via network 140. Specifically, scraping tool 106 accesses the target(s) through a proxy server(s) to obtain the target's response data. While executing the data collection request, scraper tool 106 communicates with webpage classifier 210 by sending the obtained response data for analysis, classification, and predicting the probability percentile of the target web page's type. Webpage classifier 210 sends a resultant data comprising a single or multiple datapoints classified and labelled, which in turn constitutes the dataset as suitable for returning to the user device 102. Coupled with the classified and labelled datapoints is the probability percentile of the target web page's type.

FIG. 2 shows a more detailed depiction of the service provider infrastructure 104 and the webpage classifier 210. FIG. 2 shows service provider infrastructure 104 comprising scraper tool 106 and webpage classifier 210. Furthermore, FIG. 2 shows webpage classifier 210 comprising API 211, HTML parser 212, metadata parser 213, data preparation unit 214 and webpage classifier model 215. The components and functionalities contained therein are employed during two operational flows—1) training of webpage classifier model 215 and 2) processing regular data collection responses for extracting relevant datapoints within and classifying them (described in FIG. 4).

Webpage classifier 210 is a component present within service provider infrastructure 104, that is responsible for receiving, at API 211, the response data from scraper tool 106 and analyzing the response data, wherein the response data is obtained from executing the previously mentioned data collection request(s). After receiving the response data from the scraper tool 106, API 211 sends the response data to HTML parser 212, which extracts the entirety of textual information and meta information from the response data. After which, HTML parser 212 returns the extracted information, i.e., the entirety of the textual information and HTML elements with their names, to API 211. Following the process described above, API 211 sends the response data to metadata parser 213, which extracts the necessary metadata information from the response data. After which, metadata parser 213 returns the extracted information, i.e., the metadata information, to API 211.

After receiving the relevant extracted information from both HTML parser 212 and metadata parser 213, API 211 sends the extracted information, i.e., the entirety of the textual information, the original URL, HTML elements and metadata information, to data preparation unit 214. Subsequently, data preparation unit 214 derives specific classification attributes from the extracted information. Some of the exemplary specific classification attributes derived by data preparation unit 214 are textual, URL, HTML element and metadata attributes. Following the extraction of the attributes mentioned above, data preparation unit 214 returns the specific classification attributes to API 211.

API 211 constructs a datapoint for each data collection response item. A datapoint comprises the original HTML page, the URL, the HTML elements, the text extracted from the HTML previously and the classification attributes derived from the above. API 211 sends the derived classification attributes to webpage classifier model 215, which creates a classification and a label for the datapoint according to the associated classification attributes, and returns the resultant classified and labelled data along with the probability percentile of the target web page's type to API 211. Consequently, API 211 sends the resultant classified and labelled data along with the probability percentile of the target web page's type to scraper tool 106, which in turn sends the above mentioned resultant data to user device 102.

There are at least two possible approaches for the webpage classifier model 215 to determine the classification with its probability percentile for a target web page: a) train one model to determine multiple categories. In this case, the webpage classifier model 215 only uses one model that can return a prediction of the category the specific set of attributes corresponds to, together with the probability score for each category. A significant advantage of the approach is the fact that a single model processes the data once. However, the results delivered are of lower accuracy; b) train separate models for each category. This is a more accurate approach, but it requires repeated data classification and labelling cycles with multiple models, one for each category. The increase in accuracy is ensured by custom-tailoring each model to each category's specific potential attributes and parameters.

Webpage classifier model 215 requires an initial training dataset that contains a vast amount of HTML data already classified and labelled correspondingly. Pursuant to running the training flow against the dataset each html datapoint should be labeled manually.

The flow of training dataset construction 300 is depicted in FIG. 3, wherein the initial set of HTML data 311, aggregated from the results of multiple instances of data collection 310, is submitted to extraction 320. Textual information (321), HTML elements (322) and metadata (324) are extracted from HTML data 311, together with the original URL attached (323) and the resultant data is submitted to preparing data 330 that comprises the steps of:

deriving text-related classification attributes (331);

deriving URL-related classification attributes (332);

deriving HTML elements-related classification attributes (333);

deriving metadata-related classification attributes (334).

The resultant set of classification attributes are further transferred to datapoint labelling 340.

During datapoint labelling 340, the datapoints are labelled at step 341, ensuring proper input while the training dataset 351 is constructed during dataset construction 350. The purpose of the manual labelling is to ensure the input for training of the webpage classifier model 215 contains data that promotes correct prediction behaviour therefore assuring better accuracy of classification. The dataset construction 350 stage of the processing results in a training dataset 351 fully prepared.

FIG. 4 demonstrates the full webpage classifier model lifecycle 400, starting with the model training 410, wherein training dataset 351 from training dataset construction 300 (in FIG. 3) is presented to the untrained model 412. Upon the training, the model reaches its production stage (webpage classifier model 215) at the stage new data processing 430. At this stage webpage classifier model 215 is ready to process requests to classify new data to classify 452. The results of classification—classification decision 431—is submitted back to the data collection 450 process, where classification processing 453 takes place, wherein the results are handed over to scraping session 451 with the final response data 461 submitted to the customer during the stage of customer handover 460.

In another aspect of the embodiment presented herein, an adaptable percentage of the classification decision 431 instances, constructed during the stage of new data processing 430, may be integrated into the training dataset 351, provided the analyzed data and the resultant classification are subjected to model training set augmentation process 420, wherein their correctness is confirmed during the step of quality assurance 421 and they are integrated into the model training dataset 351. The continuous quality assured input for updating training dataset 351 ensures correctness of future classifications by webpage classifier model 215.

FIG. 5 is an exemplary flow diagram, providing an overview of the route a scraping request takes. In step 502, user device 102 sends a scraping request to scraper tool 106 present within the service provider infrastructure 104. Scraper tool 106, being the entry point to the service provider infrastructure 104, receives the request from user device 102 and proceeds to execute the request. Accordingly, in step 504 scraper tool 106 proceeds to execute the scraping request. However, scraper tool 106 executes the scraping request through proxy server 130. Therefore, as a part of step 504, scraper tool 106 sends the scraping request to proxy server 130. Subsequently, in step 506, proxy server 130 forwards the scraping request to target 134. In step 508, target 134 receives and processes the scraping request forwarded by proxy server 130. Afterwhich, in step 510, target 134 responds to the scraping request with the necessary data. Specifically, in step 510, target 134 sends the necessary data to proxy server 130 as a response to the scraping request. Consequently, in step 512, proxy server 130 forwards the response data from target 134 to scraper tool 106.

In step 514, scraper tool 106 submits the response data obtained from proxy server 130, to webpage classifier 210 for analyzing, predicting classification category, labelling, and determining the classification category probability percentile. The probability percentile will show the probability of what category the web page obtained from target 134 predictably belongs to. Accordingly, in step 516, webpage classifier 210 analyzes, predicts the classification category, labels the HTML data item submitted correspondingly and determines the probability percentile for the classification category predicted. Subsequently, in step 518, webpage classifier (WCL) 210 returns to scraper tool 106 the category predicted for to the response data, together with the probability percentile of the webpage from target 134 belonging to a certain web page category, such as for example an e-commerce product page, an e-commerce search page, or hotel listing page, etc. Finally in step 520, scraper tool 106 returns the classified data together with the probability percentile of target's 134 web page category type to user device 102.

FIGS. 6A and 6B depict in a more detailed manner the route that the response data takes and the operations the data undergoes in order to be transformed from the original raw and uncategorized HTML format obtained from the target Web servers to a structured, classified and labelled dataset.

Starting within scraper tool 106, at step 602 the response obtained from the target Web server is submitted in its entirety for classification and transformation to API 211, which is a component and the integration interface of WCL 210. The data here is an HTML file of the response, HTML data item further on, and the original URL. Consequently the HTML data item is transferred at step 604 to an internal WCL 210 component — HTML parser 212, for extracting at step 606 text from HTML input, together with HTML tags, classes, id attributes of HTML elements, and variables. At step 608 the output is returned by HTML parser 212 to API 211 as text blocks with HTML tags, classes, ids, and variables.

During the following step 610 API 211 submits the original HTML data item to metadata parser 213. At step 612 the metadata tags within the HTML data item are identified and extracted with their values, whereas at step 614 the data extracted is returned to API 211.

At step 616 API 211 constructs a datapoint containing the URL, the original HTML data item, and the classification elements comprising the text blocks extracted, HTML elements and metadata elements, all extracted from the HTML file. At step 618 API 211 proceeds to submit the datapoint for processing to dataset preparation unit 214, wherein DPU 214 processes the datapoint and derives the classification attributes by performing steps to identify and evaluate classification elements within the datapoint that are pertinent for classification. A more detailed description of data preparation is disclosed as one of the many potential ways to prepare data for Machine Learning model based classification.

Classification attribute derivation comprises the activities performed to identify and process the elements of the original HTML file relevant for classification, wherein the processing results in the derivation of the HTML data item classification attributes that form a flat-structured plurality of objects with no hierarchy, vertical or horizontal relations, and can be categorized as follows:

One category can be the textual attributes. During step 620 the data preparation unit 214 isolates information from already extracted text elements. Textual classification attributes help to understand the notional landscape of the text which is crucial when deciding the category of the page. Here are some examples of text related attributes:
text length
text length ratio with html length
sentences count
average sentence length
counts of specific keywords, such as:
Add to cart
Deliver
Buy
Discount
Sale

Another category is URL attributes that are derived during step 622, as demonstrated in FIG. 6B, that is a continuation diagram of FIG. 6A flow. Essential and relevant information may be deduced from the URL. For example, the count of ‘I’ in URL may denote the location in the webpage hierarchy structure, wherein the higher count corresponds to a lower probability of a landing page. URL features may comprise:
URL length
URL path length (count of ‘/’)
ends with “.html”.

Yet another category is HTML attributes. They are derived at step 624, wherein the information about the structure of the HTML page is examined in order to identify the HTML elements that contain specific keywords relevant to identification of the page's category. Another aspect of this examination is the scrutiny of the HTML code structure itself e.g., total count of HTML tags in a page. As an example there is a higher probability that a landing page will have less complex HTML structure than a search page or a page dedicated to a product. Some attributes associated with HTML elements comprise, but are not limited to:

Specific keywords count in html tree element variable names, such as:
Price
Availability
Brand
Product
Description
Sale
Discount
external links count
internal links count
images count
max depth
total nodes count

Metadata related attributes are derived at step 626. An HTML data item contains metadata information in its HTML source code. Some of this information, contained in meta tags within pages, include essential and non-ambiguous signs of a category that the page can be classified as. Some of the metadata-related classification attributes comprise:

Webpage type, explicitly defined by the owner of the Webpage.

specific keywords present within the metadata keys, (e.g., “price”, “availability”, “brand” name, “offering price”, etc).

The results of classification element identification and evaluation, as well as classification attribute derivation, are returned to API 211 at step 628, wherein the entirety of the datapoint is submitted at step 630 to webpage classifier model 215, for the actual classification effort at step 632, wherein the model predicts the category of the datapoint and labels the datapoint accordingly. As a prerequisite for this step the datapoint at this stage contains at least the original HTML data item and the corresponding URL, as well as the set of classification attributes derived by dataset preparation unit 214. At step 634, the model returns the classification category for the datapoint to API 211, together with the probability score associated with the classification category predicted for the datapoint. At this stage the dataset at API 211 contains the datapoint classified, i.e., predictively associated with a particular category. For example, if data preparation unit 214 and webpage classifier model 215 were used to predict for multiple webpages in scope which of the pages belong to the category “product page”, at this point API 211 can assemble a dataset containing the HTML data items submitted for classification, supplementing each of the HTML data item with the classification decision together with the probability score, and process it further accordingly e.g., by performing further analytical steps or returning the dataset to the requesting party.

At step 636 API 211 updates the datapoint with the classification obtained during step 634, wherein at step 638 the updated datapoint is returned to the original requesting party.

In some of the embodiments the Webpage Classifier 210 may operate based on multiple categorization models (set of categories), wherein a requesting user device may submit preferences as to which classification model is required, via parameters of the request.

In another embodiment the classification model employed may be an implementation of one of the following Machine Learning models—Bag of words, Naïve Bayes algorithm, Support vector machines, Logistic Regression, Random Forest classifier, Extreme Gradient Boosting Model, Convolutional Neural Network or Recurrent Neural Network.

In yet another embodiment a classification decision at a classification platform is submitted for quality assurance wherein the classification assigned is examined and confirmed. The classification decision subjected to quality assurance is categorized as correct and becomes a part of future machine learning classification model training and is incorporated into the corresponding training set.

Any of the above embodiments herein may be rearranged and/or combined with other embodiments. Accordingly, the concepts herein are not to be limited to any embodiment disclosed herein. Additionally, the embodiments can take the form of entirely hardware or comprising both hardware and software elements. Portions of the embodiments may be implemented in software, which includes but is not limited to firmware, resident software, microcode, etc. FIG. 7 illustrates a computing system 700 in which a computer readable medium 706 may provide instructions for performing any of the methods disclosed herein.

Furthermore, the embodiments can take the form of a computer program product accessible from the computer readable medium 706 providing program code for use by or in connection with a computer or any instruction execution system. For the purposes of this description, the computer readable medium 706 can be any apparatus that can tangibly store the program for use by or in connection with the instruction execution system, apparatus, or device, including the computing system 700.

The medium 706 can be any tangible electronic, magnetic, optical, electromagnetic, infrared, or semiconductor system (or apparatus or device). Examples of a computer readable medium 706 include a semiconductor or solid-state memory, magnetic tape, a removable computer diskette, a random-access memory (RAM), NAND flash memory, a read-only memory (ROM), a rigid magnetic disk, and an optical disk. Some examples of optical disks include compact disk—read only memory (CD-ROM), compact disk—read/write (CD-R/W) and digital versatile disc (DVD).

The computing system 700, suitable for storing and/or executing program code, can include one or more processors 702 coupled directly or indirectly to memory 708 through a system bus 710. The memory 708 can include local memory employed during actual execution of the program code, bulk storage, and cache memories which provide temporary storage of at least some program code in order to reduce the number of times code is retrieved from bulk storage during execution. Input/output or I/O devices 704 (including but not limited to keyboards, displays, pointing devices, etc.) can be coupled to the system either directly ox through intervening I/O controllers. Network adapters may also be coupled to the system to enable the computing system 700 to become coupled to other data processing systems, such as through host systems interfaces 712, or remote printers or storage devices through intervening private or public networks. Modems, cable modems, and Ethernet cards are just a few of the currently available types of network adapters.

Although several embodiments have been described, one of ordinary skill in the art will appreciate that various modifications and changes can be made without departing from the scope of the embodiments detailed herein. Accordingly, the specification and figures are to be regarded in an illustrative rather than a restrictive sense, and all such modifications are intended to be included within the scope of the present teachings. The benefits, advantages, solutions to problems, and any element(s) that may cause any benefit, advantage, or solution to occur or become more pronounced are not to be construed as a critical, required, or essential features or elements of any or all the claims. The invention(s) are defined solely by the appended claims including any amendments made during the pendency of this application and all equivalents of those claims as issued.

Identifiers, such as “(a),” “(b),” “(i),” “(ii),” etc., are sometimes used for different elements or steps. These identifiers are used for clarity and do not necessarily designate an order for the elements or steps.

Moreover, in this document, relational terms such as first and second, and the like may be used solely to distinguish one entity or action from another entity or action without necessarily requiring or implying any actual such relationship or order between such entities or actions. The terms “comprises”, “comprising”, “has”, “having”, “includes”, “including”, “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without additional constraints, preclude the existence of additional identical elements in the process, method, article, and/or apparatus that comprises, has, includes, and/or contains the element. The terms “a” and “an” are defined as one or more unless explicitly stated otherwise herein. The terms “approximately”, “about” or any other version thereof, are defined as being close to as understood by one of ordinary skill in the art. A device or structure that is “configured” in a certain way is configured in at least that way, but may also be configured in ways that are not listed. For the indication of elements, a singular or plural forms can be used, but it does not limit the scope of the disclosure and the same teaching can apply to multiple objects, even if in the current application an object is referred to in its singular form.

The embodiments detailed herein are provided to allow the reader to quickly ascertain the nature of the technical disclosure. It is submitted with the understanding that it will not be used to interpret or limit the scope or meaning of the claims. In addition, in the foregoing Detailed Description, it is demonstrated that multiple features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment in at least some instances. Thus, the following claims are hereby incorporated into the Detailed Description, with each claim standing on its own as separately claimed subject matter.

This disclosure presents method for classifying a web page of a data collection response, comprising:

(a) receiving the data collection response that was scraped from a data collection target according to a data collection request wherein the request originates at a requesting user device;

(b) obtaining, from the data collection response at least one of the following: (i) an HTML data item, wherein the HTML data item constitutes a single webpage, (ii) a URL item wherein the URL item represents the webpage location in the interne;

(c) obtaining classification elements comprising at least one of the following: (i) a plurality of text blocks from the HTML data item, (ii) HTML elements from the HTML data item, (iii) metadata from the HTML data item, and (iv) URL elements from URL item;

(d) deriving classification attributes form the classification elements obtained in (c);

(e) applying a machine learning classification model to the classification attributes to determine a classification category for the HTML data item; and

(f) communicating the classification category determined in (e) to the requesting user device.

The method is presented, wherein the data collection response is in HTML format.

The method is presented, wherein the data collection response is in MHTML format.

The method is presented, further comprising processing the data collection response in MHTML format to extract the HTML data item.

The method is presented, wherein the obtaining (c) comprises obtaining the classification attributes assigned to the HTML data item at least in part from the HTML elements, the HTML elements comprising HTML tags, classes, ids and variables.

The method is presented, wherein the applying (e) comprises applying the classification attributes to a plurality of machine learning classification models, each of the plurality of machine learning classification models trained to identify whether the HTML data item belongs to a category.

The method is presented, wherein the plurality of machine learning classification models each determine a classification probability indicating a likelihood that the HTML data item belongs to the category that the respective machine learning classification model is trained to detect.

The method is presented, wherein the machine learning classification model employed is, but not limited to, one of the following: Bag of words, Naïve Bayes algorithm, Support vector machines, Logistic Regression, Random Forest classifier, Extreme Gradient Boosting Model.

The method is presented, wherein the classification category determined at step (e) is coupled with the classification probability calculated by the machine learning classification model.

The method is presented, further comprising submitting the classification category determined at step (e) for quality assurance to be examined and confirmed as valid through human-driven analysis.

The method is presented, wherein the classification category subjected to quality assurance is categorized as correct and becomes a part of future machine learning classification model training and is incorporated into the corresponding training set.

The method is presented, wherein the communicating (f) is executed via a mediating component such as a scraper tool.

The method is presented, further comprising determining whether the data collection response includes any identifiable classification elements wherein step (e) occurs when the collection response is determined to include at least one identifiable classification element.

The method is presented, wherein the classification category is selected from a group including an e-commerce product page, an e-commerce search page, and hotel listing page.

The method is presented, wherein the obtaining (b) occurs via a proxy server.

1. A method for classifying a web page in a data collection response, comprising:
(a) receiving the data collection response that was scraped from a data collection target according to a data collection request wherein the request originates at a requesting user device;
(b) obtaining, from the data collection response at least one of the following: (i) HyperText Markup Language (HTML) data item, wherein the HTML data item constitutes a single webpage, (ii) a uniform resource locator (URL) item wherein the URL item represents the webpage location in the internet;
(c) obtaining classification elements comprising at least one of the following: (i) a plurality of text blocks from the HTML data item, (ii) HTML elements from the HTML data item, (iii) metadata from the HTML data item, and (iv) URL elements from the URL item;
(d) deriving classification attributes form from the classification elements obtained in (c);
(e) applying a machine learning classification model to the classification attributes to determine a classification category for the HTML data item; and
(f) communicating the classification category determined in (e) to the requesting user device.

2. The method of claim 1, wherein the data collection response is in HTML format.

3. The method of claim 1, wherein the data collection response is in MIME encapsulation of aggregate HTML documents (MHTML) format.

4. The method of claim 3, further comprising processing the data collection response in MHTML format to extract the HTML data item.

5. The method of claim 1, wherein obtaining (c) comprises obtaining the classification attributes assigned to the HTML data item at least in part from the HTML elements, the HTML elements comprising HTML tags, classes, identifiers, and variables.

6. The method of claim 1, wherein the applying (e) comprises applying the classification attributes to a plurality of machine learning classification models, each of the plurality of machine learning classification models trained to identify whether the HTML data item belongs to a category. (Original) The method of claim 6, wherein the plurality of machine learning classification models each determine a classification probability indicating a likelihood that the HTML data item belongs to the category that the respective machine learning classification model is trained to detect.

8. The method of claim 1, wherein the machine learning classification model employed is, but not limited to, one of the following: Bag of words, Naïve Bayes algorithm, Support vector machines, Logistic Regression, Random Forest classifier, Extreme Gradient Boosting Model.

9. The method of claim 1, wherein the classification category determined at step (e) is coupled with the a classification probability calculated by the machine learning classification model.

10. The method of claim 1, further comprising submitting the classification category determined at step (e) for quality assurance to be examined and confirmed as valid through human-driven analysis.

11. The method of claim 10 wherein the classification category subjected to quality assurance is categorized as correct and becomes a part of future machine learning classification model training and is incorporated into the a corresponding training set.

12. The method of claim 1, wherein communicating (f) is executed via a mediating component such as a scraper tool.

13. The method of claim 1, further comprising determining whether the data collection response includes any identifiable classification elements, and wherein step (e) occurs when the collection response is determined to include at least one identifiable classification element.

14. The method of claim 1, wherein the classification category is selected from a group including an e-commerce product page, an e-commerce search page, and a hotel listing page.

15. The method of claim 1, wherein the obtaining (b) occurs via a proxy server.

16. A non-transitory computer-readable device having instructions stored thereon that, when executed by at least one computing device, cause the at least one computing device to perform operations, the operations comprising:
(a) receiving the data collection response that was scraped from a data collection target according to a data collection request wherein the request originates at a requesting user device;
(b) obtaining, from the data collection response at least one of the following: (i) an HyperText Markup Language (HTML) data item, wherein the HTML data item constitutes a single webpage, (ii) a uniform resource locator (URL) item wherein the URL item represents the webpage location in the internet;
(c) obtaining classification elements comprising at least one of the following: (i) a plurality of text blocks from the HTML data item, (ii) HTML elements from the HTML data item, (iii) metadata from the HTML data item, and (iv) URL elements from the URL item;
(d) deriving classification attributes from the classification elements obtained in (c);
(e) applying a machine learning classification model to the classification attributes to determine a classification category for the HTML data item; and
(f) communicating the classification category determined in (e) to the requesting user device.

17. The device of claim 16, wherein the data collection response is in HTML format.

18. The device of claim 16, wherein the data collection response is in MIME encapsulation of aggregate HTML documents (MHTML) format.

19. The device of claim 18, the operations further comprising processing the data collection response in MHTML format to extract the HTML data item.

20. The device of claim 16, wherein obtaining (c) comprises obtaining the classification attributes assigned to the HTML data item at least in part from the HTML elements, the HTML elements comprising HTML tags, classes, identifiers, and variables.
